(19) United States
(12) Patent Application Publication
(10) Pub. No.: US 2026/0279759 A1
(43) Pub. Date: Sep. 17, 2026

(54) APPARATUS AND METHOD OF MANUFACTURING ELECTRODE

(71) Applicant: SK ON CO., LTD., Seoul (KR)

(72) Inventors: Sang Heon SONG, Daejeon (KR); Jae Hun KIM, Daejeon (KR); Yoon Sung OH, Daejeon (KR)

(21) Appl. No.: 19/550,308

(22) Filed: Feb. 26, 2026

(30) Foreign Application Priority Data
Mar. 14, 2025 (KR) 10-2025-0033532

(51) Int. Cl. H01M 4/04

(52) U.S. Cl. CPC H01M 4/0404; H01M 4/0435; H01M 4/0471

(57) ABSTRACT

An apparatus for manufacturing an electrode including a coated portion and a non-coated portion, includes a heater heating the non-coated portion by irradiating a laser, and a rolling roller rolling the coated portion by pressing the coated portion. In a width direction of the electrode, the non-coated portion includes an inner region disposed adjacently to the coated portion and an outer region located farther from the coated portion than the inner region, the heater irradiates the outer region and the inner region with lasers having different average powers, and an average power per unit length of the laser irradiated to the outer region by the heater has a value greater than an average power per unit length of the laser irradiated to the inner region.

### CROSS-REFERENCE TO RELATED APPLICATION(S)

This patent document claims the priority and benefits of Korean Patent Application No. 10-2025-0033532 filed on Mar. 14, 2025, the disclosure of which is incorporated herein by reference in its entirety.

### TECHNICAL FIELD

The disclosure and implementations disclosed in this patent document generally relate to an apparatus and method of manufacturing an electrode having a coated portion and a non-coated portion, and more particularly, to an apparatus and method of manufacturing an electrode by rolling a coated electrode to which a coated portion is applied.

### BACKGROUND

Secondary battery cells are a type of energy storage device that may be charged with electricity and discharged therefrom. Secondary battery cells are widely used in various devices that use electricity as a power source. For example, secondary battery cells are used in a wide range of fields, from small devices such as mobile phones, laptops, and tablets to vehicles and energy storage devices.

A secondary battery cell may include a case (for example, a can, a pouch, or the like) and an electrode assembly. The electrode assembly includes an electrode and a separator and may be housed within the case. The electrode may include a coated portion with an active material coated on foil and a non-coated portion without the active material. The coated electrode (electrode substrate), in which the active material is coated on a portion of foil (current collector), may undergo a rolling process (or pressing process) to improve the energy density per unit volume. The coated electrode may be manufactured into an electrode through a rolling process.

### SUMMARY

The coated electrode (electrode substrate) may be provided such that the density of an electrode mixture layer increases and the volume thereof is reduced through a rolling process. During the rolling process, the coated portion is directly pressed, while the non-coated portion is indirectly elongated by the elongation of the coated portion. Therefore, the difference in elongation between the coated and non-coated portions may cause electrode fracture. This fracture frequency increases as the difference in elongation between the coated and non-coated portions increases.

The present disclosure may be implemented in some embodiments to provide an apparatus and method of manufacturing an electrode, in which electrode fracture may be prevented or reduced.

According to an aspect of the present disclosure, an apparatus and method of manufacturing an electrode, in which the difference in elongation between the coated and non-coated portions may be reduced, may be provided.

According to an aspect of the present disclosure, an apparatus and method for manufacturing an electrode may be provided, in which a difference in elongation amount depending on the location of the non-coated portion may be controlled in the width direction of the electrode.

According to an aspect of the present disclosure, an apparatus and method for manufacturing an electrode may be provided, in which variation in tensile strength depending on the location of the non-coated portion is reduced in the width direction of the electrode.

According to an aspect of the present disclosure, an apparatus and method for manufacturing an electrode may be provided, in which an appearance defect (for example, folds, wrinkles, ripples, or the like) in the non-coated portion is reduced.

A battery cell including an electrode manufactured by the apparatus for manufacturing an electrode and/or the method of manufacturing an electrode according to an embodiment of the present disclosure may be widely applied to devices within green technology fields such as electric vehicles, battery charging stations, and other battery-based solar and wind power generation. In addition, a battery cell including an electrode manufactured by the apparatus for manufacturing an electrode and/or the method of manufacturing an electrode according to an embodiment of the present disclosure may be used in eco-friendly electric vehicles, hybrid vehicles, and the like to prevent climate change by suppressing air pollution and greenhouse gas emissions.

In some embodiments of the present disclosure, an apparatus for manufacturing an electrode including a coated portion on which an active material is applied to foil and a non-coated portion on which no active material is applied to the foil, includes a heater heating the non-coated portion by irradiating a laser to the non-coated portion; and a rolling roller rolling the coated portion by pressing the coated portion. In a width direction of the electrode, the non-coated n includes an inner region disposed adjacently to the coated portion and an outer region located farther from the coated portion than the inner region, the heater irradiates the outer region and the inner region with lasers having different average powers; and an average power per unit length of the laser irradiated to the outer region by the heater has a value greater than an average power per unit length of the laser irradiated to the inner region.

In an embodiment, the heater may include a laser generator generating laser and a beam splitter distributing the laser transmitted from the laser generator to respective preset regions to have different average powers.

In an embodiment, the heater may further include a beam homogenizer uniformly supplying the laser transmitted from the beam splitter to respective preset regions.

In an embodiment, a laser power applied to the inner region by the heater may have a constant value throughout the inner region, and a laser power applied to the outer region by the heater may have a constant value throughout the outer region.

In an embodiment, in the width direction of the electrode, the outer region may include a first region disposed adjacently to the inner region and a second region located further from the inner region than the first region, the heater may irradiate the inner region, the first region, and the second region with laser having different average powers, respectively, and an average power per unit length of the laser applied to the non-coated portion by the heater may increase in the order of the inner region, the first region, and the second region.

In an embodiment, a laser power applied to the first region by the heater may have a constant value throughout the first region, and a laser power applied to the second region by the heater may have a constant value throughout the second region.

In an embodiment, a laser power applied to the non-coated portion by the heater may increase in a stepwise manner by at least two or more steps in the width direction of the electrode.

In an embodiment, a laser power applied to the inner region and a laser power applied to the outer region by the heater may each be set such that an average tensile strength in the outer region has a value equal to or less than an average tensile strength in the inner region.

In an embodiment, a laser power applied to the inner region and a laser power applied to the outer region by the heater may each be set such that an average tensile strength in the outer region has a value of 0.5 or more and 1.0 or less of an average tensile strength in the inner region.

The apparatus for manufacturing an electrode according to an embodiment may further include a non-coated portion elongation part pressurizing the non-coated portion and elongating the non-coated portion.

In some embodiments of the present disclosure, a method of manufacturing an electrode including a coated portion on which an active material is applied to foil and a non-coated portion on which no active material is applied to the foil, includes heating the non-coated portion by irradiating a laser to the non-coated portion; and pressing the coated portion and rolling the coated portion. In a width direction of the electrode, the non-coated portion includes an inner region disposed adjacently to the coated portion and an outer region located further from the coated portion than the inner region. In the heating, an average power per unit length of the laser irradiated to the outer region has a value greater than an average power per unit length of the laser irradiated to the inner region.

In an embodiment, in the heating, a laser power applied to the inner region may have a constant value throughout the inner region, and in the heating, a laser power applied to the outer region may have a constant value throughout the outer region.

In an embodiment, in the width direction of the electrode, the outer region may include a first region disposed adjacently to the inner region and a second region located further from the inner region than the first region, and in the heating, an average power per unit length of the laser applied to the non-coated portion may increase in the order of the inner region, the first region, and the second region.

In an embodiment, a laser power applied to the inner region during the heating may have a constant value throughout the inner region, a laser power applied to the first region during the heating may have a constant value throughout the first region, and a laser power applied to the second region during the heating may have a constant value throughout the second region.

In an embodiment, the inner region may have a wider width than a width of the first region and a width of the second region.

In an embodiment, an average power per unit length of the laser applied to the non-coated portion during the heating may increase stepwise by at least two or more steps in the width direction of the electrode.

In an embodiment, in the heating, the average power per unit length of the laser irradiated to the inner region and the average power per unit length of the laser irradiated to the outer region may each be set such that an average tensile strength in the outer region has a value equal to or less than an average tensile strength in the inner region.

In an embodiment, in the heating, the average power per unit length of the laser irradiated to the inner region and the average power per unit length of the laser irradiated to the outer region may each be set such that an average tensile strength in the outer region has a value of 0.5 or more and 1.0 or less of an average tensile strength in the inner region.

The method of manufacturing an electrode according to an embodiment may further include elongating the non-coated portion by pressing the non-coated portion.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating an apparatus for manufacturing an electrode according to an embodiment.

FIG. 2 is a perspective view schematically illustrating an example of a heater illustrated in FIG. 1.

FIG. 3 is a plan view of the electrode illustrated in FIG. 1.

FIGS. 4A, 4B and 4C are graphs illustrating the laser power per unit length, tensile strength, and surface temperature in the width direction, of a non-coated portion of an apparatus for manufacturing an electrode according to a comparative example, respectively.

FIGS. 5A, 5B and 5C are graphs illustrating the laser power 1 per unit length, tensile strength, and surface temperature in the width direction, of a non-coated portion of an apparatus for manufacturing an electrode according to an embodiment, respectively.

FIG. 6 is a graph illustrating the tensile strength and camber of the non-coated portion for the embodiment and the comparative example according to a width-direction position.

FIG. 7 is a cross-sectional view illustrating a modified embodiment of the apparatus for manufacturing an electrode illustrated in FIG. 1.

FIG. 8 is a flowchart illustrating a method of manufacturing an electrode according to an embodiment.

FIG. 9 is a flowchart illustrating a method of manufacturing an electrode according to the modified embodiment of FIG. 8.

### DETAILED DESCRIPTION

Features of the present disclosure disclosed in this patent document are described by example embodiments with reference to the accompanying drawings.

Hereinafter, the present disclosure will be described in detail with reference to the attached drawings. However, these are merely illustrative and the present disclosure is not limited to the detailed embodiments described as examples.

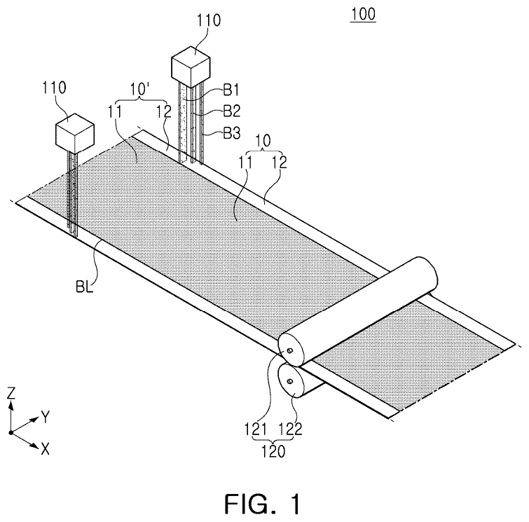

With reference to FIGS. 1 to 3, an apparatus 100 for manufacturing an electrode according to an embodiment will be described.

FIG. 1 is a perspective view schematically illustrating an apparatus 100 for manufacturing an electrode according to an embodiment.

Referring to FIG. 1, an embodiment of the present disclosure provides an apparatus for manufacturing an electrode 10 including a coated portion 11 on which an active material is applied to foil and a non-coated portion 12 on which no active material is applied to the. According to an embodiment, an apparatus 100 for manufacturing an electrode may include a heater 110 that heats the non-coated portion 12 by irradiating the non-coated portion 12 with a laser, and a rolling roller 120 that pressurizes the coated portion 11 to roll the coated portion 11.

In the present disclosure, the term “coated electrode 10′” includes a coated portion 11 and a non-coated portion 12, and is defined as meaning a state prior to processing by the apparatus 100 for manufacturing an electrode according to an embodiment. The coated electrode 10′ may refer to an electrode substrate on which slurry is applied to foil. The coated electrode 10′ may undergo a drying process after the slurry is applied to the foil. For example, in the present disclosure, the term “coated electrode 10′” may refer to a state before the non-coated portion 12 is heated by the heater 110 according to an embodiment.

In the present disclosure, the term “electrode 10” is defined to refer to a state in which processing is in progress by the apparatus 100 for manufacturing an electrode according to an embodiment, and a state in which processing is completed. For example, in the present disclosure, the term “electrode 10” may refer to a state in which the non-coated portion 12 is heated by the heater 110 and a state in which rolling is completed by the rolling roller 120.

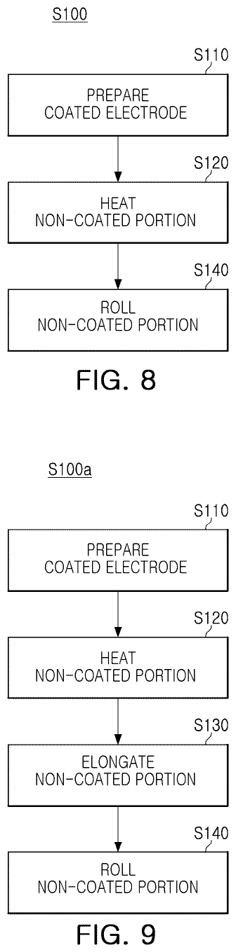

A coated electrode (electrode substrate) 10′ may be provided for the manufacture of at least one of a cathode and an anode. The coated electrode 10′ may be formed by applying slurry to foil (or current collector) made of aluminum or copper. The slurry contains an active material, a conductive agent, and a binder and may be applied to one or both sides of the foil. The coated electrode 10′ may include a coated portion 11 to which the slurry is applied and a non-coated portion 12 to which the slurry is not applied. The coated portion 11 is also referred to as a retained portion, and the non-coated portion 12 is also referred to as an uncoated portion. The apparatus 100 for manufacturing an electrode and the method of manufacturing an electrode (S100 in FIG. 8) according to an embodiment may be applied to the manufacture of a cathode and an anode.

The non-coated portion 12 may be respectively disposed on both sides of the coated portion 11. The coated portion 11 and the non-coated portion 12 may be separated by a boundary line BL. The coated electrode 10′ may be processed in the longitudinal direction (X).

Although FIG. 1 illustrates a state in which the non-coated portion 12 is formed on both sides of a single coated portion 11, respectively, the coated portion 11 may be provided as multiple coated portions 11, and in this case, the non-coated portion 12 may be disposed between two coated portions 11.

The heater 110 may heat the non-coated portion 12 by irradiating a laser onto the non-coated portion 12. The heater 110 may set different heating conditions for respective locations of the non-coated portion 12 along the width direction (Y) of the electrode 10. For example, the heater 110 may set different heating amounts for areas close to the coated portion 11 and areas farther from the coated portion 11 along the width direction (Y) of the non-coated portion 12. The heater 110 may increase the heating amount of a region located farther away from the coated portion 11 in the width direction (Y) of the non-coated portion 12 more than the heating amount of a region close to the coated portion 11. If the heating amount is high, the temperature and/or heating efficiency of the region to be heated may increase more than if the heating amount is low. The heating amount may be set by the output (or power) and/or intensity of the laser irradiated to the non-coated portion 12.

The heater 110 may be configured to irradiate laser beams to a plurality of regions in the width direction (Y) of the electrode 10 or the width direction (Y) of the non-coated portion 12. The laser beams irradiated to the plurality of regions may have different outputs (or powers) and/or intensities. For example, the heater 110 may include a first laser beam B1 irradiated to a region close to the coated portion 11 in the width direction (Y) of the non-coated portion 12, a second laser beam B2 irradiated to a region located farther from the coated portion 11 than the first laser beam B1, and a third laser beam B3 irradiated to a region located farther from the coated portion 11 than the second laser beam B2. The intensity and/or output of each laser beam may increase in the order of the first laser beam B1, the second laser beam B2, and the third laser beam B3.

As the output or intensity of the laser beam increases, the heating temperature of the irradiated area increases, which may increase the surface temperature of the non-coated portion 12. The tensile strength of the non-coated portion 12 may vary depending on the heating temperature of the non-coated portion 12. By adjusting the output or intensity of the laser beam in respective areas irradiated on the non-coated portion 12, the tensile strength of the non-coated portion 12 may be adjusted according to the position thereof in the width direction (Y).

The rolling roller 120 may pressurize and roll the coated portion 11. The rolling roller 120 may include at least one pair of rollers to pressurize the coated portion 11 from the upper and lower portions of the electrode 10. For example, the rolling roller 120 may include an upper roller 121 and a lower roller 122 that pressurize the coated portion 11 at the upper and lower portions of the electrode 10, respectively. The rolling roller 120 may roll the electrode 10 over the entire width of the electrode 10. For example, the axial lengths of the upper roller 121 and the lower roller 122 may be greater than the width of the electrode 10 so that the upper roller 121 and the lower roller 122 may have widths that cover both the coated portion 11 and the non-coated portion 12, respectively. However, the axial lengths of the upper roller 121 and the lower roller 122 may also have lengths that do not cover at least a portion of the non-coated portion 12. The axial lengths may correspond to the width direction (Y) of the electrode 10.

The rolling pressure of the rolling roller 120 may be determined by considering the thickness reduction of the active material (or slurry) applied to the foil, the thickness of the coated portion 11 in the rolled state, or the like.

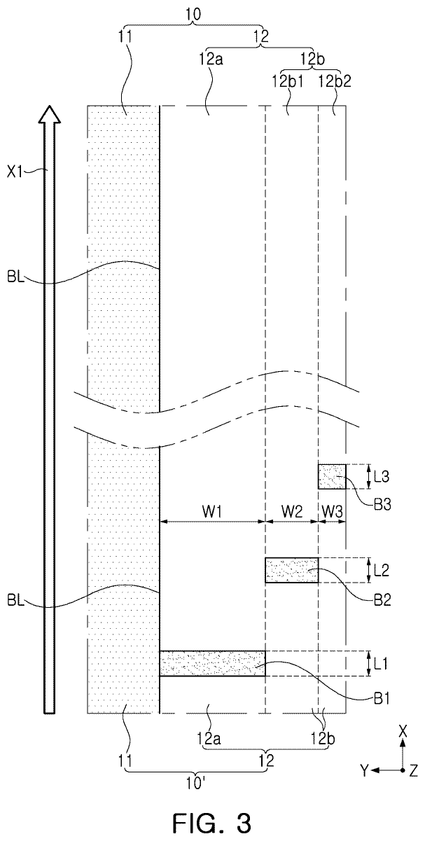

The rolling roller 120 may be disposed behind the heater 110 in the direction of travel of the electrode 10 (X1 in FIG. 3). Therefore, the rolling roller 120 may roll the coated portion 11 while the non-coated portion 12 is heated by the heater 110.

When the electrode 10 is rolled by the rolling roller 120, the coated portion 11 is elongated by the direct pressure of the rolling roller 120, and the non-coated portion 12 may be elongated indirectly by the elongation of the coated portion 11. Rolling the electrode 10 while the non-coated portion 12 is heated may facilitate the elongation of the coated portion 11.

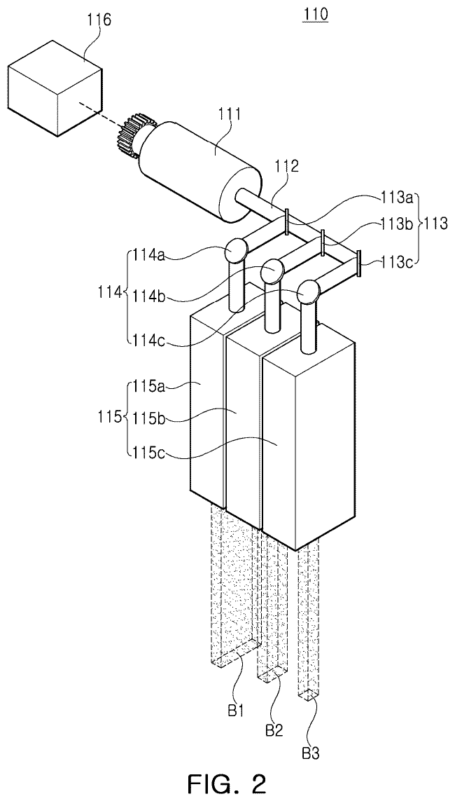

FIG. 2 is a perspective view schematically illustrating an example of the heater 110 illustrated in FIG. 1. An example of the heater 110 will be described with reference to FIG. 2.

For example, the heater 110 may include a laser generator 116 generating laser and a beam splitter 113 distributing the laser transmitted from the laser generator 116 to respective preset regions so that the laser has different average powers.

The laser generator 116 may generate laser using stimulated emission of radiation. For example, a laser oscillator may be used as the laser generator 116. The laser oscillator may generate electromagnetic waves in the infrared, visible, or ultraviolet ranges using stimulated radiation.

The laser generated from the laser generator 116 may be incident on a collimator 111. The collimator 111 may parallelize light and particle beams. The collimator 111 may make the laser beam directive. The laser emitted from the collimator 111 may travel along a conduit 112.

A beam splitter 113 may be disposed in the conduit 112. The beam splitter 113 may distribute the output (or power) of the laser beam by adjusting the transmittance. The beam splitter 113 may split the laser into a plurality of laser beams. The beam splitter 113 may assign the output of each laser beam to a preset value. As an example, the beam splitter 113 may include a first splitter 113a for distributing the output of the first laser beam B1, a second splitter 113b for distributing the output of the second laser beam B2, and a third splitter 113c for distributing the output of the third laser beam B3. Each laser beam passing through the beam splitter 113 may be irradiated to a preset area in the non-coated portion 12.

The heater 110 may include a mirror 114 that changes the path of the laser beam so that the laser beam distributed from the beam splitter 113 is irradiated to a preset area. The mirror 114 may include a first mirror 114a that changes the path of the first laser beam B1 distributed from the first splitter 113a, a second mirror 114b that changes the path of the second laser beam B2 distributed from the second splitter 113b, and a third mirror 114c that changes the path of the third laser beam B3 distributed from the third splitter 113c. For example, the mirror 114 may be a high-reflectivity mirror with a reflectivity ranging from 99.8% to 99.999%, but the present invention is not limited thereto.

The heater 110 may additionally include a beam homogenizer 115 uniformly supplying the laser beam transmitted from the beam splitter 113 to respective preset regions. The beam homogenizer 115 may uniformly distribute the laser beam intensity across the area to which it is irradiated. The laser beam irradiated from the beam homogenizer 115 may have a linear shape or a quadrangular shape with a predetermined area. However, the shape of the laser beam irradiated from the beam homogenizer 115 may be varied.

The beam homogenizer 115 may include a first homogenizer 115a uniformly outputting a first laser beam B1 input from a first splitter 113a, a second homogenizer 115b uniformly outputting a second laser beam B2 input from a second splitter 113b, and a third homogenizer 115c uniformly outputting a third laser beam B3 input from a third splitter 113c.

FIG. 3 is a plan view of the electrode 10 illustrated in FIG. 1.

Referring to FIGS. 1 and 2, the coated electrode 10′ and the electrode 10 may each include a coated portion 11 on which an active material is coated on foil, and a non-coated portion 12 on which no active material is coated. The coated portion 11 and the non-coated portion 12 may be divided based on a boundary line BL.

In the width direction (Y) of the electrode 10, the non-coated portion 12 may include an inner region 12a disposed adjacently to the coated portion 11 and an outer region 12b located further from the coated portion 11 than the inner region 12a.

When the non-coated portion 12 is divided into the inner region 12a and the outer region 12b, the outer region 12b may be defined as the remaining portion excluding the inner region 12a. The inner region 12a may be defined as the region of the non-coated portion 12 closest to the boundary line BL. The inner region 12a may be in contact with the boundary line BL. The outer region 12b may consist of a single region or may be divided into multiple regions. When the outer region 12b is divided into a plurality of regions, the tensile strength of the non-coated portion 12 may be more precisely controlled at each location in the width direction (Y) of the electrode 10.

In the width direction (Y) of the electrode 10, the outer region 12b may include a first region 12b1 disposed adjacently to the inner region 12a and a second region 12b2 located further from the inner region 12a than the first region 12b1. However, the number of regions constituting the outer region 12b may vary, such as one, three, or more.

Laser beams may be irradiated to the inner region 12a and the outer region 12b, respectively. The first laser beam B1 may be irradiated to the inner region 12a. A second laser beam B2 may be irradiated to the first region 12b1 of the outer region 12b, and a third laser beam B3 may be irradiated to the second region 12b2 of the outer region 12b.

The first laser beam B1 may have a first width W1 in the width direction (Y) of the electrode 10 and a first length L1 in the traveling direction (X1) of the electrode 10. The second laser beam B2 may have a second width W2 in the width direction (Y) of the electrode 10 and a second length L2 in the traveling direction (X1) of the electrode 10. The third laser beam B3 may have a third width W3 in the width direction (Y) of the electrode 10 and a third length L3 in the traveling direction (X1) of the electrode 10. The first length L1, second length L2, and third length L3 may have the same value as the electrode 10, but are not limited thereto. For example, if the overall width of the non-coated portion 12 is 25 mm, the first width W1 may have a value of 15 to 25 mm, the second width W2 may have a value of 1 to 10 mm, and the third width W3 may have a width of 1 to 10 mm. For example, the first length L1, second length L2, and third length L3 may have a value of 0.5 mm.

The heater 110 may irradiate lasers having different average powers to the outer region 12b and the inner region 12a. The average power (Watt/mm) per unit length of the laser irradiated to the outer region 12b by the heater 110 may have a greater value than the average power (Watt/mm) per unit length of the laser irradiated to the inner region 12a. In this case, the unit length is a value measured in the width direction (Y) of the electrode 10.

In the case where the entire non-coated portion is heated under the same heating conditions as in the related art, the inner region 12a is indirectly elongated by a large amount due to the elongation of the coated portion 11 during the rolling process (or pressing process) by the rolling roller, but the outer region 12b may be indirectly elongated in an elongation amount less than that of the inner region 12a by the elongation of the coated portion 11 because the outer region 12b is located far from the coated portion 11. If the difference in the elongation amount according to the width direction (Y) position of the non-coated portion 12 is large, a breakage phenomenon may occur in the electrode 10 during the rolling process. In addition, if the entire non-coated portion 12 is laser-heated under the same heating conditions, swell may occur due to thermal expansion of the non-coated portion 12. Swell is a phenomenon in which the non-coated portion 12 causes displacement in the thickness direction, and the swell may occur most significantly at the edge portion (for example, the second region) of the outer region 12b. At the edge where significant swells occur, the laser focus shifts, reducing the heating efficiency of the edge and increasing the tensile strength at the edge portion of the outer region 12b. This increase in the tensile strength of the outer region 12b may lead to appearance defects such as folds and wrinkles.

As in an embodiment of the present disclosure, when the average power (Watt/mm) per unit length of the laser beam irradiated to the outer region 12b has a value greater than the average power per unit length of the laser beam irradiated to the inner region 12a, the heating temperature of the outer region 12b may be higher than the heating temperature of the inner region 12a. Consequently, the elongation amounts of the inner and outer regions 12a may be maintained similarly, reducing or preventing the risk of fracture of the electrode 10 during the rolling process. Additionally, a decrease in heating efficiency at the edge of the outer region 12b may be prevented, thereby improving the phenomenon of increased tensile strength at the edge and thus reducing appearance defects.

The heater 110 may irradiate laser beams with different average powers to the inner region 12a, first region 12b1, and second region 12b2, respectively. The average power per unit length of the laser beam applied to the non-coated portion 12 by the heater 110 may increase in the order of the inner region 12a, first region 12b1, and second region 12b2.

If the average power per unit length of the laser increases in the order of the inner region 12a, first region 12b1, and second region 12b2, the change in elongation amount in the inner region 12a, first region 12b1, and second region 12b2 may be small, thereby reducing or improving the occurrence of fracture in the electrode 10 during the rolling process. Furthermore, by preventing a decrease in the heating temperature in the second region 12b2 of the outer region 12b, the tensile strength of the second region 12b2 may be increased, and appearance defects in the non-coated portion 12 may be improved.

The laser power applied to the non-coated portion 12 by the heater 110 may be increased in at least two or more steps in the width direction (Y) of the electrode 10. When the laser power applied to the non-coated portion 12 is increased stepwise, the difference in elongation amount between the inner region 12a and the outer region 12b of the non-coated portion 12 may be maintained similarly, and the tensile strength of the outer region 12b may be set to a preset value.

The laser power (output) applied to the inner region 12a by the heater 110 may have a constant value throughout the inner region 12a, and the laser power applied to the outer region 12b by the heater 110 may have a constant value throughout the outer region 12b. When each laser beam provides a constant output across the irradiated area, uniform heating may be obtained for respective regions, and the elongation amount, tensile strength, and/or heating temperature may be easily controlled in respective regions.

The laser power applied to each of the inner region 12a and the outer region 12b may be uniformly provided across each preset region by the beam homogenizer 115.

If the outer region 12b has a plurality of regions, the laser power applied to the plurality of respective regions may have a constant value for the plurality of respective regions. For example, the laser power applied to the first region 12b1 of the outer region 12b may have a constant value throughout the first region 12b1, and the laser power applied to the second region 12b2 of the outer region 12b may have a constant value throughout the second region 12b2. The laser power applied to each of the first region 12b1 and the second region 12b2 may be uniformly provided to each region by the beam homogenizer 115.

The inner region 12a may have a wider width than the outer region 12b. When the width of the outer region 12b is narrower than that of the inner region 12a, the heating temperature may be precisely controlled in the outer region 12b, which has a relatively small elongation amount. Depending on the heating temperature control, the tensile strength of the outer region 12b may be more precisely controlled.

When the outer region 12b is divided into a plurality of regions, the inner region 12a may have a wider width than the first region 12b1 and the second region 12b2. The first width W1 of the inner region 12a may have a greater value than the second width W2 of the first region 12b1, and the second width W2 of the first region 12b1 may have a greater value than the third width W3 of the second region 12b2. When the first region 12b1 and second region 12b2 are narrow, the heating temperature may be precisely controlled in the first region 12b1 and second region 12b2, which have relatively small elongation amounts. Controlling the heating temperature allows for more precise control of the tensile strength of the first region 12b1 and second region 12b2. When the width of the second region 12b2 is narrower than the width of the first region 12b1, the heating temperature may be precisely controlled in the second region 12b2, which has relatively small elongation amounts, and the tensile strength of the second region 12b2 may also be more precisely controlled.

As an example, the inner region 12a may have a value of 50 to 90% of the total width of the non-coated portion 12, the first region 12b1 may have a value of 5 to 40% of the total width of the non-coated portion 12, and the second region 12b2 may have a value of 5 to 40% of the total width of the non-coated portion 12. The inner region 12a may have a value of 50 to 70% of the total width of the non-coated portion 12, the first region 12b1 may have a value of 25 to 35% of the total width of the non-coated portion 12, and the second region 12b2 may have a value of 5 to 15% of the total width of the non-coated portion 12.

The output (or power) of the laser irradiated to the inner region 12a by the heater 110 and the output (or power) of the laser irradiated to the outer region 12b may be each set so that the average tensile strength in the outer region 12b has a value equal to or less than the average tensile strength in the inner region 12a. When the outer region 12b is divided into a plurality of regions, the average tensile strength in the region closest to the edge of the outer region 12b, for example, the second region when the outer region is divided into the first region and the second region, may be set to have a value equal to or less than the average tensile strength in the inner region 12a. The average tensile strength may be defined as the average of the tensile strengths measured at a plurality of measuring points for each region. The plurality of measuring points may be set at regular intervals in the width direction (Y) for each region. The average tensile strength may be a value measured after the rolling process.

If the average tensile strength in the outer region 12b has a value equal to or less than the average tensile strength in the inner region 12a, appearance defects (for example, folds, wrinkles, or the like) occurring in the non-coated portion 12 may be reduced. Conversely, if the average tensile strength in the outer region 12b is higher than the average tensile strength in the inner region 12a, appearance defects such as folds and wrinkles may occur in the non-coated portion 12.

The laser power irradiated to the inner region 12a by the heater 110 and the laser power irradiated to the outer region 12b may be respectively set such that the average tensile strength of the outer region 12b has a value of 0.5 or more and 1.0 or less of the average tensile strength of the inner region 12a. If the outer region 12b is divided into multiple regions, the average tensile strength of the region closest to the edge of the outer region 12b (for example, the second region) may be set such that the average tensile strength is 0.5 or more and 1.0 or less than the average tensile strength of the inner region 12a.

If the average tensile strength of the outer region 12b is less than 0.5 of the average tensile strength of the inner region 12a, a fracture phenomenon may occur at the welded joint where the cell tab or current collector is welded to the non-coated portion 12. If the average tensile strength of the outer region 12b exceeds 1.0 of the average tensile strength of the inner region 12a, appearance defects such as folding and wrinkles may occur in the non-coated portion 12.

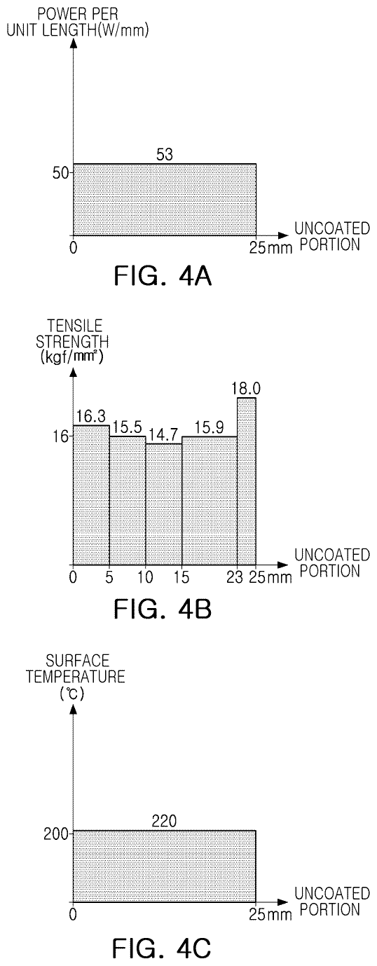

FIGS. 4A, 4B and 4C are graphs depicting the laser power per unit length, tensile strength, and surface temperature in the width direction (Y) of the non-coated portion 12 of an apparatus 100 for manufacturing an electrode according to a comparative example.

The comparative examples depicted in FIGS. 4A, 4B and 4C illustrate cases where the entire non-coated portion was heated with the laser under identical heating conditions.

In the comparative example, as shown in FIG. 4A, the power per unit length irradiated across the entire width of the non-coated portion was maintained constant. As shown in FIG. 4C, the surface temperature remained constant.

When laser heating a non-coated portion under identical heating conditions across the entire width thereof, thermal expansion of the non-coated portion may cause swells. These swells are most pronounced at the edges of the outer region. The laser focus shifts at these edges, reducing heating efficiency and increasing tensile strength. As illustrated in FIG. 4B, in a comparative example where the entire non-coated portion is laser-heated under identical heating conditions, the tensile strength of the outer region may increase. This increase in tensile strength in the outer region may lead to appearance defects such as folding and wrinkles.

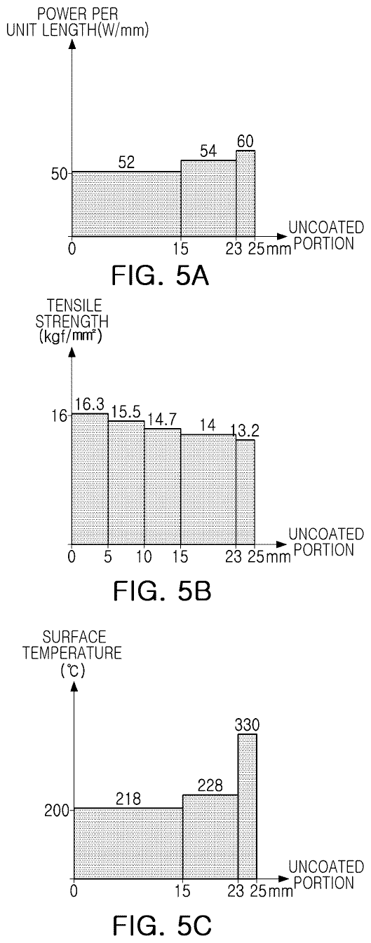

FIGS. 5A, 5B and 5C are graphs illustrating the laser power per unit length, tensile strength, and surface temperature in the width direction (Y) of the non-coated portion 12 of an apparatus 100 for manufacturing an electrode according to an embodiment, respectively.

The embodiments shown in FIGS. 5A, 5B and 5C represent a case where lasers having different average powers are irradiated to the outer region 12b and the inner region 12a. For example, the average power per unit length of the laser irradiated to the outer region 12b was set to have a value greater than the average power (Watt/mm) per unit length of the laser irradiated to the inner region 12a.

Specifically, as illustrated in FIG. 5A, the inner region 12a, located 0 to 15 mm from the boundary line (BL in FIG. 3) between the coated portion 11 and the non-coated portion 12, was irradiated with the first laser beam B1 at the first output (power) per unit length. The first region 12b1, located 15 to 23 mm from the boundary line, was irradiated with the second laser beam B2 at the second output (power) per unit length. The second region 12b2, located 23 to 25 mm from the boundary line, was irradiated with the third laser beam B3 at the third output (power) per unit length. For example, the average power (output) per unit length of the laser applied to the non-coated portion 12 by the heater 110 increased in the order of the inner region 12a, the first region 12b1, and the second region 12b2.

In this case, as shown in FIG. 5B, the tensile strength of the inner region 12a, located at 0 to 15 mm, gradually decreased. The tensile strength of the first region 12b1, located at 15 to 23 mm, decreased more than the tensile strength of the inner region 12a. The tensile strength of the second region 12b2, located at 23 to 25 mm, decreased more than the tensile strength of the first region 12b1.

Referring to FIG. 5C, as the heating temperatures (surface temperatures) of the inner region 12a, first region 12b1, and second region 12b2 increase, even when swells occur in the non-coated portion 12, a decrease in heating efficiency at the edge of the outer region 12b may be prevented. Therefore, in the embodiment, the phenomenon of increased tensile strength at the edge of the outer region 12b may be prevented, and appearance defects such as folding and wrinkles may be prevented or improved.

Furthermore, since the heating temperature of the outer region 12b is higher than the heating temperature of the inner region 12a, the elongation amounts of the inner region 12a and outer region 12b may be maintained similarly, thereby reducing or preventing the occurrence of fracture in the electrode 10 during the rolling process.

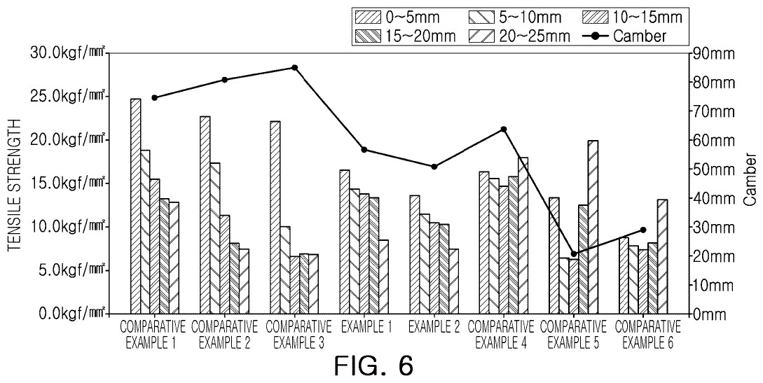

FIG. 6 is a graph showing the tensile strength of the non-coated portion 12 according to the width direction (Y) position and the camber value of the electrode 10 for the examples and comparative examples.

The graph in FIG. 6 shows the tensile strength in each region when the non-coated portion 12 is divided into five equal regions in the width direction (Y). For the examples and comparative examples, the tensile strength is measured at regions of 0 to 5 mm (region 1), 5 to 10 mm (region 2), 10 to 15 mm (region 3), 15 to 20 mm (region 4), and 20 to 25 mm (region 5) from the boundary line (BL in FIG. 3) between the coated portion 11 and the non-coated portion 12, respectively, when the width of the non-coated portion 12 is 25 mm.

An electrode 10 having a coated portion 11 and a non-coated portion 12 may experience a camber phenomenon, where the electrode 10 bends toward the non-coated portion 12, due to a difference in elongation amount between the coated portion 11 and the non-coated portion 12 during a rolling process. The camber value may increase as the difference in elongation amount between the coated portion 11 and the non-coated portion 12 increases.

If the camber phenomenon worsens, the tip of the electrode 10 may bend when winding the electrode assembly, causing a meandering defect, which may prevent the electrode assembly from being laminated in the correct position. If the electrode assembly is not laminated in the correct position, a short circuit may occur internally due to reasons such as the cathode non-coated portion 12 coming into contact with the anode active material, the anode non-coated portion 12 coming into contact with the cathode active material, or the cathode non-coated portion 12 and the anode non-coated portion 12 coming into contact. Therefore, it is necessary to significantly reduce the camber phenomenon of the electrode 10 during the rolling process. The camber amount indicates the degree of curvature of the electrode 10, and may be expressed as the difference value between the position of the non-coated portion 12 at the end of the electrode 10 and the normal position of the non-coated portion 12 without curvature. This camber amount may be expressed based on the width direction (Y) of the electrode 10. As the camber value decreases, the camber phenomenon may also be reduced.

Comparative Examples 1, 2, and 3 illustrate cases where the entire non-coated portion 12 was heated using induction heating annealing (IHA). In Comparative Example 1, the non-coated portion 12 was heated with an output of 2.8 kW, in Comparative Example 2, the non-coated portion 12 was heated with an output of 3.4 KW, and in Comparative Example 3, the non-coated portion 12 was heated with an output of 4.0 kW.

Induction heating annealing (IHA) is a heating method that causes the heated material (metal) to generate heat on its own through induction heating. Induction heating annealing is a technology that prevents fracture of the electrode 10 by increasing the elongation of the non-coated portion 12 by deforming the metal structure. However, since it is a technology that induces current in the heated object through an electromagnetic field, the heating area cannot be controlled. Furthermore, since induction heating annealing utilizes an electromagnetic field, a narrow gap with the heated object should be maintained, and since the current density is uneven at each heating location, uniform heating may be difficult.

Examples 1 and 2 illustrate cases where the non-coated portion 12 was heated by irradiating a laser beam onto the non-coated portion 12. In Examples 1 and 2, the average laser power (output) applied to the outer region of the non-coated portion 12 was greater than that applied to the inner region. In Examples 1 and 2, additional laser heating was applied to the outer region of the non-coated portion 12, making the power applied to the outer region greater than that applied to the inner region. In Example 1, the entire non-coated portion 12 was heated by irradiating the laser with a power of 1350 watts, and the outer edge of the non-coated portion 12 was further heated with a power of 1130 watts. In Example 2, the entire non-coated portion 12 was heated with a power of 1400 watts, and the outer edge of the non-coated portion 12 was further heated with a power of 1130 watts.

Comparative Example 4 involved heating the entire non-coated portion 12 by irradiating the laser beam. In Comparative Example 4, the laser beam was irradiated at the same or similar power across the inner and outer regions of the non-coated portion 12. In Comparative Example 4, the entire non-coated portion 12 was heated with a power of 1300 watts.

Comparative Example 5 illustrates a case where a laser beam was irradiated onto the non-coated portion 12 to heat the non-coated portion 12. In Comparative Example 5, the average laser power applied to the inner region of the non-coated portion 12 was greater than that applied to the outer region. In Comparative Example 5, additional laser heating was applied to the inner region of the non-coated portion 12, increasing the power applied to the inner region to be greater than the power applied to the outer region. In Comparative Example 5, the entire non-coated portion 12 was heated by irradiating the same with a laser beam at an output of 800 Watts, and a 10 mm inner region of the non-coated portion 12 was additionally heated at a power of 1,000 Watts.

Comparative Example 6 illustrates a case where a laser beam was irradiated onto the non-coated portion 12 to heat the entire non-coated portion 12. Comparative Example 6 irradiated the inner and outer regions of the non-coated portion 12 with a laser beam at the same or similar output. In Comparative Example 6, the entire non-coated portion 12 was laser-heated at an output of 1, 500 Watts.

When induction heating annealing was used to heat the entire non-coated portion 12, as in Comparative Examples 1, 2, and 3, uniform heating was difficult, and the heating amount could not be controlled along the width direction (Y) of the non-coated portion 12. Consequently, Comparative Examples 1, 2, and 3 experienced a significant difference in the elongation amount between the inner region 12a and the outer region 12b, resulting in an increase in the camber value. An increase in the camber value may lead to meandering defects during winding of the electrode assembly, which may prevent lamination of the electrode assembly in the correct position, potentially resulting in problems such as short circuits. Furthermore, as in Comparative Examples 2 and 3, when the difference in tensile strength between the inner region 12a and the outer region 12b increases, the tensile strength of the outer region 12b cannot be maintained at a consistent level, leading to a problem of easy fracture at the welded joint where the cell tab or current collector is welded to the non-coated portion 12.

Comparative Examples 4 and 6 illustrate cases where the non-coated portion 12 was heated entirely by irradiating the laser beam onto the non-coated portion 12. Comparative Example 5 illustrates cases where the average laser power applied to the inner region of the non-coated portion 12 was greater than that applied to the outer region. In Comparative Examples 4, 5, and 6, the tensile strength at the edge of the outer region 12b had a value greater than the tensile strength of the inner region 12a, resulting in appearance defects such as folds and wrinkles.

On the other hand, when the average laser power applied to the outer region of the non-coated portion 12 is greater than that applied to the inner region, as in Examples 1 and 2, the difference in tensile strength between the inner region 12a and the outer region 12b is small, reducing weld defects. Furthermore, the difference in elongation amount between the inner region 12a and the outer region 12b is relatively small, resulting in a small camber value. Furthermore, the tensile strength of the outer region 12b is equal to or less than that of the inner region 12a, reducing appearance defects.

The weld portion is the region where the cell tab or current collector is welded on the non-coated portion 12, and may include at least a portion of the region 10 to 25 mm away from the boundary line (BL in FIG. 3).

TABLE 1

| | Adequate Tensile | Camber | Whether appearance |
|---|---|---|---|
| Classification | Strength | Value | is defective |
| Comparative | OK | NG | OK |
| Example 1 | | | |
| Comparative | NG (Large difference | NG | OK |
| Example 2 | in tensile strength | | |
| | between inner and | | |
| | outer regions) | | |
| Comparative | NG (Large difference | NG | OK |
| Example 3 | in tensile strength | | |
| | between inner and | | |
| | outer regions) | | |
| Example 1 | OK | OK | OK |
| Example 2 | OK | OK | OK |
| Comparative | NG (Higher tensile | NG | NG (Folding and |
| Example 4 | strength on outer | | wrinkle in 10-15 mm |
| | region) | | range) |
| Comparative | NG (Higher tensile | OK | NG (Folding and |
| Example 5 | strength on outer | | wrinkle in 15-20 mm |
| | region) | | range) |
| Comparative | NG (Higher tensile | OK | NG (Folding and |
| Example 6 | strength on outer | | wrinkle in 15-20 mm |
| | region) | | range) |

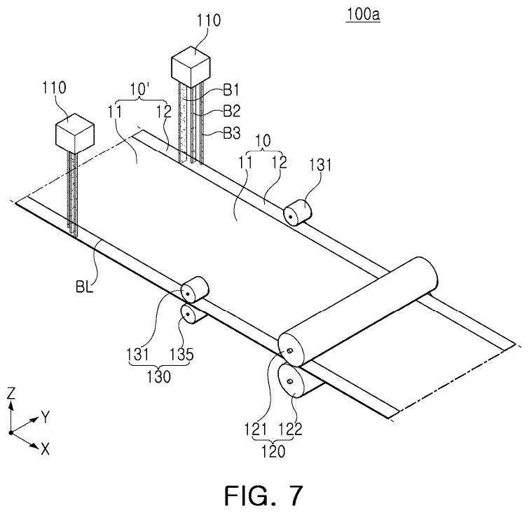

FIG. 7 is a cross-sectional view illustrating a modified embodiment of the apparatus 100 for manufacturing an electrode illustrated in FIG. 1.

Compared to the apparatus 100 for manufacturing an electrode illustrated in FIG. 1, the apparatus for manufacturing an electrode 100a according to the modified embodiment differs in that it additionally includes a non-coated portion elongation part 130. The descriptions of the heater 110 and rolling roller 120 with reference to FIGS. 1 to 3, 4A, 4B, 4C, 5A, 5B, 5C, and 6 also apply to the modified embodiment of FIG. 7.

As illustrated in FIG. 7, the apparatus for manufacturing an electrode 100a according to the modified embodiment may additionally include a non-coated portion elongation part 130 that pressurizes and elongate the non-coated portion 12.

The non-coated portion elongation part 130 may elongate the heated non-coated portion 12 so that the non-coated portion 12 has a uniform elongation amount overall in the width direction (Y).

The non-coated portion elongation part 130 may be disposed above and below the electrode 10 to apply pressure to the non-coated portion 12 from above and below. For example, the unit may include an upper elongation roller 131 disposed above the non-coated portion 12 and a lower elongation roller 135 disposed below the non-coated portion 12. However, the non-coated portion elongation part 130 is not limited to a roller, and a belt, press, or other device may also be used.

FIG. 8 is a flowchart illustrating a method of manufacturing an electrode (S100) according to an embodiment.

Referring to FIG. 8 and FIG. 1 to FIG. 3, a method of manufacturing an electrode (S100) according to an embodiment is described.

The method of manufacturing an electrode (S100) according to an embodiment relates to a method of manufacturing an electrode 10 including a coated portion 11 on which an active material is applied to foil and a non-coated portion 12 on which no active material is applied to the foil. The method of manufacturing an electrode (S100) according to an embodiment may include a heating process (S120) of heating the non-coated portion 12 by irradiating the non-coated portion 12 with a laser, and a rolling process (S140) of pressing the coated portion 11 to roll the coated portion 11. In the width direction (Y) of the electrode 10, the non-coated portion 12 may include an inner region 12a disposed adjacently to the coated portion 11 and an outer region 12b located further from the coated portion 11 than the inner region 12a. In the heating process (S120), the average power per unit length of the laser beam irradiated to the outer region 12b may have a value greater than the average power per unit length of the laser beam irradiated to the inner region 12a.

The description of the heater 110 in FIGS. 1 to 3, 4A, 4B, 4C, 5A, 5B, 5C, and 6 may be applied to the heating process (S120), and the description of the rolling roller 120 may be applied to the rolling process (S140). Below, only the main contents of the method of manufacturing an electrode (S100) will be described.

First, a preparation process (S110) may be performed to prepare a coated electrode 10′ including a coated portion 11 on which an active material is coated on foil and a non-coated portion 12 on which no active material is coated. The descriptions of the coated portion 11 and the non-coated portion 12 of the electrode 10 and the coated electrode 10′ in FIGS. 1 to 3, 4A, 4B, 4C, 5A, 5B, 5C, and 6 may be applied to the method of manufacturing an electrode (S100 of FIG. 8).

As in the embodiment of the present disclosure, in the heating process (S120), if the average power per unit length of the laser irradiated to the outer region 12b has a value greater than the average power per unit length of the laser irradiated to the inner region 12a, the heating temperature of the outer region 12b may have a value higher than the heating temperature of the inner region 12a. Accordingly, since the elongation amount of the inner region 12a and outer region 12b may be maintained similarly, the occurrence of fracture in the electrode 10 during the rolling process (S140) may be reduced or improved. Furthermore, a decrease in heating efficiency at the edge of the outer region 12b may be prevented, thereby improving the phenomenon of increased tensile strength at the edge, thereby reducing appearance defects.

The laser power (output) applied to the inner region 12a during the heating process (S120) may have a constant value throughout the inner region 12a, and the laser power applied to the outer region 12b during the heating process (S120) may have a constant value throughout the outer region 12b. When each laser beam provides a constant output across the irradiated area, uniform heating may be obtained for each region, and the elongation amount, tensile strength, and/or heating temperature may be easily controlled in each region.

In the width direction (Y) of the electrode 10, the outer region 12b includes a first region 12b1 disposed adjacently to the inner region 12a and a second region 12b2 located further from the inner region 12a than the first region 12b1. During the heating process (S120), the average power per unit length of the laser applied to the non-coated portion 12 may increase in the order of the inner region 12a, the first region 12b1, and the second region 12b2.

When the average power per unit length of the laser increases in the order of the inner region 12a, the first region 12b1, and the second region 12b2, the elongation amount changes in the inner region 12a, the first region 12b1, and the second region 12b2 may be small, thereby reducing or improving the occurrence of fracture in the electrode 10 during the rolling process. In addition, by preventing a decrease in the heating temperature in the second region 12b2 of the outer region 12b, the phenomenon of increasing the tensile strength of the second region 12b2 and improving appearance defects in the non-coated portion 12 may be improved.

When the non-coated portion 12 includes an inner region 12a and an outer region 12b having a first region 12b1 and a second region 12b2, the laser power applied to the inner region 12a during the heating process (S120) may have a constant value across the inner region 12a, the laser power applied to the first region 12b1 during the heating process (S120) may have a constant value across the first region 12b1, and the laser power applied to the second region 12b2 during the heating process (S120) may have a constant value across the second region 12b2. If each laser beam provides a constant output across the irradiated area, uniform heating may be obtained for each region, and the elongation amount, tensile strength, and/or heating temperature may be easily controlled in each region.

The inner region 12a may have a wider width than a width of the first region 12b1 and a width of the second region 12b2. If the outer region 12b is narrower than the inner region 12a, the heating temperature may be precisely set in the outer region 12b, which has a relatively smaller elongation amount. Depending on the heating temperature setting, the tensile strength of the outer region 12b may be more precisely controlled.

If the outer region 12b is divided into multiple regions, the inner region 12a may have a wider width than the first region 12b1 and the second region 12b2. When the widths of the first region 12b1 and second region 12b2 are relatively narrower than the width of the inner region 12a, the heating temperature and/or tensile strength may be precisely controlled in the first region 12b1 and second region 12b2, which have relatively small elongation amounts. When the width of the second region 12b2 is smaller than the width of the first region 12b1, the heating temperature and/or tensile strength may be precisely controlled in the second region 12b2, which has relatively smaller elongation amounts.

During the heating process (S120), the average power per unit length of the laser applied to the non-coated portion 12 may be increased in a stepwise manner by at least two or more steps in the width direction (Y) of the electrode 10. When the laser power applied to the non-coated portion 12 is gradually increased, the difference in elongation amount between the inner region 12a and the outer region 12b of the non-coated portion 12 may be maintained similarly, and the tensile strength of the outer region 12b may be set to a preset value.

In the heating process (S120), the average power per unit length of the laser irradiated to the inner region 12a and the average power per unit length of the laser irradiated to the outer region 12b may be set such that the average tensile strength in the outer region 12b has a value equal to or less than the average tensile strength in the inner region 12a. When the outer region 12b is partitioned into a plurality of regions, the average tensile strength in the region closest to the edge of the outer region 12b (for example, the second region 12b2 if the outer region 12b is partitioned into the first region 12b1 and the second region 12b2) may be set to have a value equal to or less than the average tensile strength in the inner region 12a.

If the average tensile strength in the outer region 12b has a value equal to or less than the average tensile strength in the inner region 12a, appearance defects (for example, folds, wrinkles, or the like) occurring in the non-coated portion 12 may be reduced. Conversely, if the average tensile strength in the outer region 12b is greater than the average tensile strength in the inner region 12a, appearance defects (for example, folds, wrinkles, or the like) may occur in the non-coated portion 12.

In the heating process (S120), the average power per unit length of the laser irradiated to the inner region 12a and the average power per unit length of the laser irradiated to the outer region 12b may be each set so that the average tensile strength of the outer region 12b has a value of 0.5 or more and 1.0 or less of the average tensile strength of the inner region 12a. If the outer region 12b is divided into multiple regions, the average tensile strength of the region closest to the edge of the outer region 12b, (for example, if the outer region 12b is divided into the first region 12b1 and the second region 12b2, the second region 12b2), may be set to has a value of 0.5 or more and 1.0 or less of the average tensile strength of the inner region 12a, respectively.

If the average tensile strength of the outer region 12b is less than 0.5 of the average tensile strength of the inner region 12a, a fracture phenomenon may occur at the weld joint where the cell tab or current collector is welded to the non-coated portion 12. If the average tensile strength of the outer region 12b exceeds 1.0 of the average tensile strength of the inner region 12a, appearance defects such as folding or wrinkling may occur in the non-coated portion 12.

FIG. 9 is a flowchart illustrating a method of manufacturing an electrode (S100a) according to the modified embodiment of FIG. 8.

Compared to the method of manufacturing an electrode (S100) illustrated in FIG. 8, the method of manufacturing an electrode (S100a) according to the modified embodiment differs in that it additionally includes a non-coated portion elongation process (S130). The descriptions of the process of preparing a coated electrode 10′ (S110), the heating process (S120) for heating the non-coated portion 12, and the rolling process (S140) for rolling the coated portion 11 may be applied to those described in FIG. 8.

As illustrated in FIG. 9, the method of manufacturing an electrode (S100a) according to the modified embodiment may additionally include a non-coated portion elongation process (S130) for elongating the non-coated portion 12 by pressing the non-coated portion 12. The non-coated portion elongation process (S130) elongates the heated non-coated portion 12 so that the non-coated portion 12 has a uniform elongation amount throughout the width direction (Y).

The above description is merely an example applying the principles of t present disclosure, and other configurations may be included without departing from the scope of the present invention. Furthermore, some components of the above-described embodiments may be omitted, and the embodiments may be combined with each other.

As set forth above, according to an embodiment, electrode fracture may be prevented or reduced.

According to an embodiment, the difference in elongation amount between the coated portion and the non-coated portion may be reduced.

According to an embodiment, the difference in elongation amount depending on the position of the non-coated portion in the width direction of the electrode may be controlled.

According to an embodiment, the variation in tensile strength depending on the position of the non-coated portion in the width direction of the electrode may be relatively small.

According to an embodiment, an electrode may be obtained with minimal appearance defects (for example, folds, wrinkles, ripples, or the like) in the non-coated portion.

Only specific examples of implementations of certain embodiments are described. Variations, improvements and enhancements of the disclosed embodiments and other embodiments may be made based on the disclosure of this patent document.

What is claimed is:

1. An apparatus for manufacturing an electrode including a coated portion on which an active material is applied to foil and a non-coated portion on which no active material is applied to the foil, the apparatus comprising:
a heater heating the non-coated portion by irradiating a laser to the non-coated portion; and
a rolling roller rolling the coated portion by pressing the coated portion,
wherein, in a width direction of the electrode, the non-coated portion includes an inner region disposed adjacently to the coated portion and an outer region located farther from the coated portion than the inner region,
the heater irradiates the outer region and the inner region with lasers having different average powers; and
an average power per unit length of the laser irradiated to the outer region by the heater has a value greater than an average power per unit length of the laser irradiated to the inner region.

2. The apparatus of claim 1, wherein the heater includes a laser generator generating laser and a beam splitter distributing the laser transmitted from the laser generator to respective preset regions to have different average powers.

3. The apparatus of claim 2, wherein the heater further includes a beam homogenizer uniformly supplying the laser transmitted from the beam splitter to respective preset regions.

4. The apparatus of claim 1, wherein in the width direction of the electrode, the outer region includes a first region disposed adjacently to the inner region and a second region located further from the inner region than the first region,
the heater irradiates the inner region, the first region, and the second region with laser having different average powers, respectively, and
an average power per unit length of the laser applied to the non-coated portion by the heater increases in the order of the inner region, the first region, and the second region.

5. The apparatus of claim 1, wherein a laser power applied to the non-coated portion by the heater increases in a stepwise manner by at least two or more steps in the width direction of the electrode.

6. The apparatus of claim 1, further comprising a non-coated portion elongation part pressurizing the non-coated portion and elongating the non-coated portion.

7. A method of manufacturing an electrode including a coated portion on which an active material is applied to foil and a non-coated portion on which no active material is applied to the foil, the method comprising:
heating the non-coated portion by irradiating a laser to the non-coated portion; and
pressing the coated portion and rolling the coated portion,
wherein, in a width direction of the electrode, the non-coated portion includes an inner region disposed adjacently to the coated portion and an outer region located further from the coated portion than the inner region, and
in the heating, an average power per unit length of the laser irradiated to the outer region has a value greater than an average power per unit length of the laser irradiated to the inner region.

8. The method of claim 7, wherein in the heating, a laser power applied to the inner region has a constant value throughout the inner region, and
in the heating, a laser power applied to the outer region has a constant value throughout the outer region.

9. The method of claim 7, wherein in the width direction of the electrode, the outer region includes a first region disposed adjacently to the inner region and a second region located further from the inner region than the first region, and
in the heating, an average power per unit length of the laser applied to the non-coated portion increases in the order of the inner region, the first region, and the second region.

10. The method of claim 9, wherein a laser power applied to the inner region during the heating has a constant value throughout the inner region,
a laser power applied to the first region during the heating has a constant value throughout the first region, and
a laser power applied to the second region during the heating has a constant value throughout the second region.

11. The method of claim 9, wherein the inner region has a wider width than a width of the first region and a width of the second region.

12. The method of claim 7, wherein an average power per unit length of the laser applied to the non-coated portion during the heating increases stepwise by at least two or more steps in the width direction of the electrode.

13. The method of claim 7, wherein in the heating, the average power per unit length of the laser irradiated to the inner region and the average power per unit length of the laser irradiated to the outer region are each set such that an average tensile strength in the outer region has a value equal to or less than an average tensile strength in the inner region.

14. The method of claim 7, wherein in the heating, the average power per unit length of the laser irradiated to the inner region and the average power per unit length of the laser irradiated to the outer region are each set such that an average tensile strength in the outer region has a value of 0.5 or more and 1.0 or less of an average tensile strength in the inner region.

15. The method of claim 7, further comprising elongating the non-coated portion by pressing the non-coated portion.
